(19) United States
(12) Patent Application Publication
(10) Pub. No.: US 2026/0365308 A1
(43) Pub. Date: Nov. 19, 2026

(54) ARMREST MOVEMENT MECHANISM

(71) Applicant: Tusas- Turk Havacilik Ve Uzay Sanayii Anonim Sirketi, Kahramankazan, Ankara (TR)

(72) Inventors: Ahmet Hakan BOZKURT, Kahramankazan, Ankara (TR); Hasan AKMAN, Kahramankazan, Ankara (TR); Ali AKCAY, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/133,756

(22) PCT Filed: Nov. 1, 2023
(86) PCT No.: PCT/TR2023/051237

§ 371 Date: May 29, 2025

(30) Foreign Application Priority Data
Nov. 29, 2022 (TR) 2022/018141

(51) Int. Cl. B64D 11/06; B64C 13/04

(52) U.S. Cl. CPC B64D 11/0644; B64C 13/0421

(57) ABSTRACT

The present invention relates to a joystick (J) used by a pilot to steer the air vehicle; at least one armrest (K), on which the pilot places his hand to use the joystick (J) in an ergonomic way; a body (2); a first rotary arm (3) and a second rotary arm (4), which are connected to the body (2) and rotate around an axis to which they are connected, so that position of the armrest (K) is changed; an armrest arm (5) with the armrest (K) thereon, which is pivotably coupled with the first rotary arm (3) and the second rotary arm (4), and enables position changes of the first rotary arm (3) and the second rotary arm (4) to be transferred to the armrest (K).

This invention relates to a movement mechanism of an armrest required by a pilot when using a joystick in air and/or space vehicles.

Pilots put their arms on the armrest while using the joystick in air and/or space vehicles. The armrest is used to provide an ergonomic use for the pilot while using the joystick, which provides control input to the air and/or space vehicle. The armrest mechanism is used to prevent the pilot from transferring uncontrolled power or to help the pilot transfer a required power even in case of exhausted. In some combat aircraft, the joystick is placed on a side panel in the cockpit, and all aircraft with a side joystick use the armrest mechanism. The pilot places his/her arm on the armrest to provide a more comfortable and precise force transfer while providing input to the joystick, without carrying the weight of his/her own arm, especially during long flight periods, thereby providing more precise force transfer to the joystick. Potential improvements in armrests, especially the design of adjustable armrest systems in next generation combat aircraft, provide significant advantages for pilots in the battlefield. Considering that the pilots using the armrest mechanism would have a wide range of sizes and weights, both position and height of the armrest must be adjustable in order to be used by different pilots. The required armrest position range is determined in the flight direction depending on the length of the pilot's forearm, and the armrest height adjustment is determined in the vertical direction depending on the pilot's shoulder height.

U.S. Pat. No. 10,870,489, which is included in the known-state of the art, discloses a four-arm mechanism that extends perpendicular to the floor and provides movement in the vertical plane in order to adjust the armrest installation length. An assistive device applies force to guide the arm support member from the first position (I) to a higher second position (II). The base, arm support member, first arm and second arm cooperate each other as a four-bar mechanism.

Thanks to an armrest movement mechanism according to the present invention, an armrest system adjustable both in position and height is provided for pilots with different usage requirements.

Another object of the present invention is to provide an ergonomic armrest design that allows the armrest to be moved aside when not in use, while at the same time not posing any obstacle to the pilot.

A further object of the present invention is to perform position adjustment and height adjustment independently of each other in armrest systems adjustable both in position and height.

The armrest movement mechanism realized to achieve the object of the invention, which is defined in the first claim and other claims dependent thereon, comprises an armrest for a pilot to place his arm; and a joystick for the pilot to control the air vehicle. A body, e.g. a bracket, is provided in the air vehicle, that enables a structural part to be fixed in a cockpit area housing the pilot. A first rotary arm and a second rotary arm are connected to the body so as to rotate in different positions, wherein the arms rotate around the axes on which they can rotate freely, allowing the mechanical position of the armrest to be adjusted by the pilot. Mechanical location and position mean the entire range of movement that the armrest can move in three-dimensional space, other than the armrest height adjustment. The armrest is located in the cylindrical hole in the armrest arm, and the armrest can rotate around its own axis longitudinally and in the cylindrical hole provided in the armrest arm. The armrest arm is supported on the first rotary arm and the second rotary arm, so as to rotate freely. Since the armrest arm is mechanically connected to the first rotary arm and the second rotary arm, position changes of the first rotary arm and the second rotary arm cause the armrest arm to change position. Since the armrest is located on the armrest arm, position changes of the armrest arm cause the armrest to change position.

The armrest movement mechanism according to the invention is located in the cockpit area of the air vehicle, where the pilot is located. Longitudinal axis (buttline) of the air vehicle is a virtual line along the length of the air vehicle that extends from the nose of the air vehicle to the rear tail longitudinally, and it is used when a global reference axis is required in aviation. The straight line is parallel and/or coaxial to the longitudinal axis of the air vehicle. When a virtual direction is drawn from the joystick to the armrest, said direction almost coincides with the straight line. In a first position (I), the pilot pushes the armrest away from himself in a forward direction towards the joystick, so that the armrest is moved on the straight line to change its position. In a second position, the pilot pulls the armrest towards himself in a backward direction, so that the armrest is moved on the straight line to change its position. The armrest moves on the almost completely linear straight line during position changes between the first position (I) and the second position (II). The body is located on right or left side of the pilot. In a third position (III), the pilot pulls the armrest towards the body on the side and moves the armrest towards the body, away from the straight line.

When the armrest movement mechanism is viewed from above in the third position (III), the first rotary arm and the second rotary arm overlap each other and move freely without any collision with each other. In case the armrest is not required, the pilot can pull the armrest to the third position (III) and open the way, preventing the armrest from hindering him. In case the armrest is to be used by the pilot, he moves the armrest from the third position (III), so as to position it in a position that best suits his body size, preferably between the second position (II) and the first position (I). The armrest position is changed by moving the armrest arm, thereby placing the armrest in the most suitable position for the pilot between the first position (I), second position (II) and third position (III), adjusting the most suitable armrest position for different pilot sizes. The armrest is stowed to the side, towards the body, in the third position (III), thus not creating any obstruction for the pilot when not in use.

In an embodiment of the invention, the armrest movement mechanism comprises the first rotary arm and the second rotary arm in the cockpit, which extend outward from the body parallel to the floor. Thanks to the connection of the first rotary arm and the second rotary arm to the body from the right or left side depending on the pilot, the armrest can be moved to the third position (III) by the pilot.

In an embodiment of the invention, in the armrest movement mechanism, the first rotary arm consists of two parts. The first rotary arm consists of two parts, with one part connected to the armrest arm above the armrest arm, and the other connected to the armrest arm under the armrest arm, both in a rotatable manner. The connector passes through the holes provided in the armrest arm and the first rotary arm, such that the armrest arm and the first rotary arm rotate around the axis on which the connector extends. Rotation axis is the axis along which the connector connecting the first rotary arm and the body extends. The rotation axes of the first rotary arm, which is provided as two separate parts, are perpendicular and linear to the ground. Thus, the first rotary arm and the second rotary arm change their positions so that the same distance remains to the ground during rotation. Connecting the first rotary arm to the armrest arm as two separate parts, one from the bottom and one from the top, reduces armrest deformation caused by the weight of the pilot arm, thereby providing ergonomics for the pilot.

In an embodiment of the invention, the armrest movement mechanism comprises the first rotary arm, which is provided as two separate parts. Each of the first rotary arms, which consists of two separate parts, has a non-linear, curved geometry from the body to the armrest arm. In this way, the second rotary arm and the first rotary arm can change position by passing over each other, and no collision or contact occurs.

In an alternative embodiment of the invention, the armrest movement mechanism comprises a roll angle, wherein the axes along which first rotary arm and second rotary arm extend longitudinally have the roll angle relative to the ground. The first rotary arm and the second rotary arm are positioned at a roll angle relative to the ground. A ball joint is provided on the connectors that connect the first rotary arm, second rotary arm and armrest arm, which are rotatably connected to each other. The ball joint allows the first rotary arm and the second rotary arm to be positioned at a roll angle relative to the body, so that the armrest can be positioned higher, especially for tall pilots, providing an ergonomic design.

In an embodiment of the invention, the armrest movement mechanism comprises the first rotary arm with a first rotary arm length. The first rotary arm length is a length between the center of rotation points where the first rotary arm is connected to the body and armrest arm. The terms length and center of rotation points mean the points in the middle, which are the geometric center points of the connectors located in the cylindrical holes at the end points of the first rotary arm, the second rotary arm and the armrest arm. Ground distance is a distance between the points where the first rotary arm and the second rotary arm are connected to the body. The second rotary arm length is a length between the points where the second rotary arm is connected to the body and armrest arm. The first armrest arm length is a length between the points where the first rotary arm and the second rotary arm are connected to the armrest arm. The first rotary arm length, ground distance, second rotary arm length and first armrest arm length are predetermined by the manufacturer, and the special ratios of the determined distances to each other significantly affect the movement limits and movement style of the mechanism. Therefore, the armrest located in the cylindrical hole at the end of the armrest arm moves almost linearly on the straight line between the first position (I) and the second position (II), while moving within the angle limits predetermined by the user, in which the mechanism rotates.

The armrest movement mechanism realized to achieve the object of the present invention is illustrated in the attached drawings, in which:

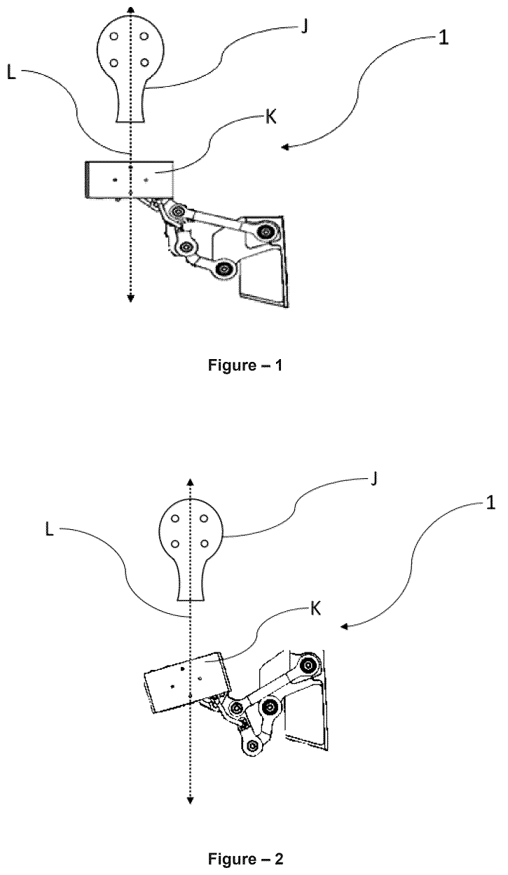

FIG. 1 is a top view of an armrest movement mechanism in the first position (I).

FIG. 2 is a top view of an armrest movement mechanism in the second position (II), when the armrest is not rotated by the pilot.

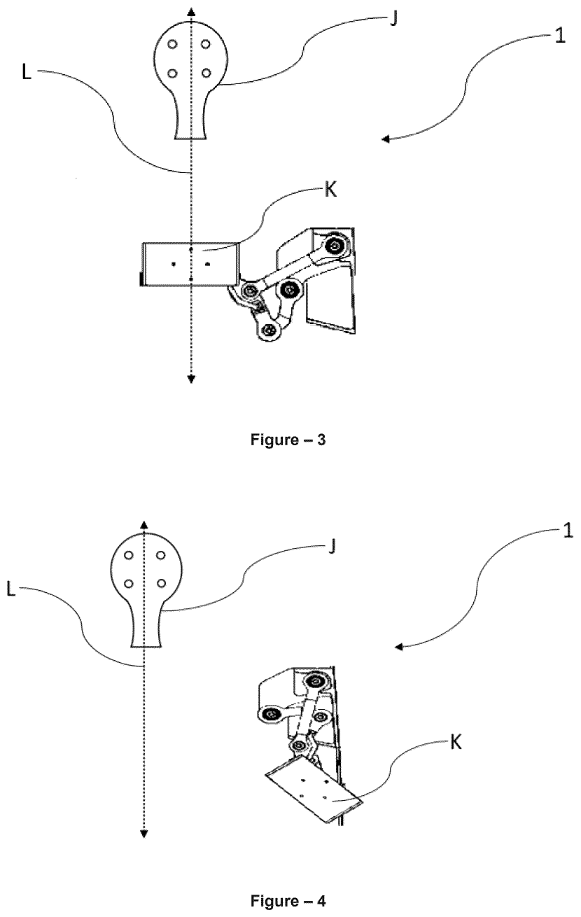

FIG. 3 is a top view of an armrest movement mechanism in the second position (II), when the armrest is rotated by the pilot.

FIG. 4 is a top view of an armrest movement mechanism in the third position (III), when the armrest is not rotated by the pilot.

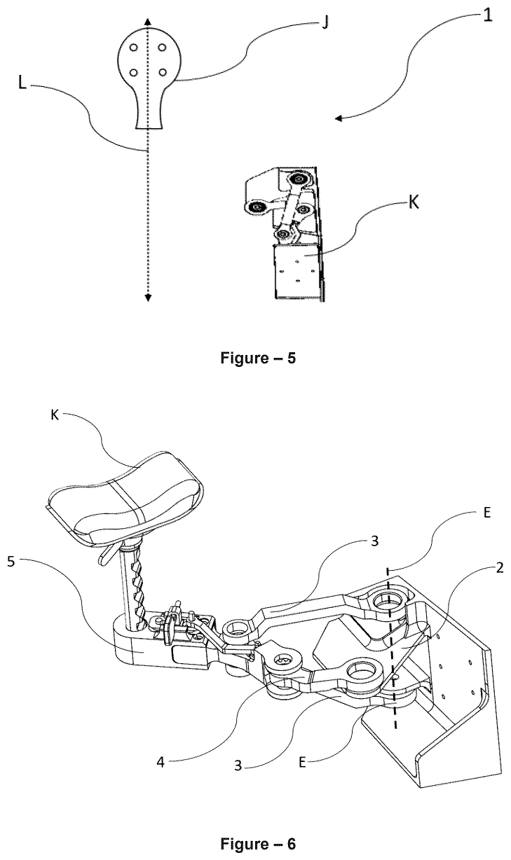

FIG. 5 is a top view of an armrest movement mechanism in the third position (III), when the armrest is rotated by the pilot.

FIG. 6 is a perspective view of an armrest movement mechanism.

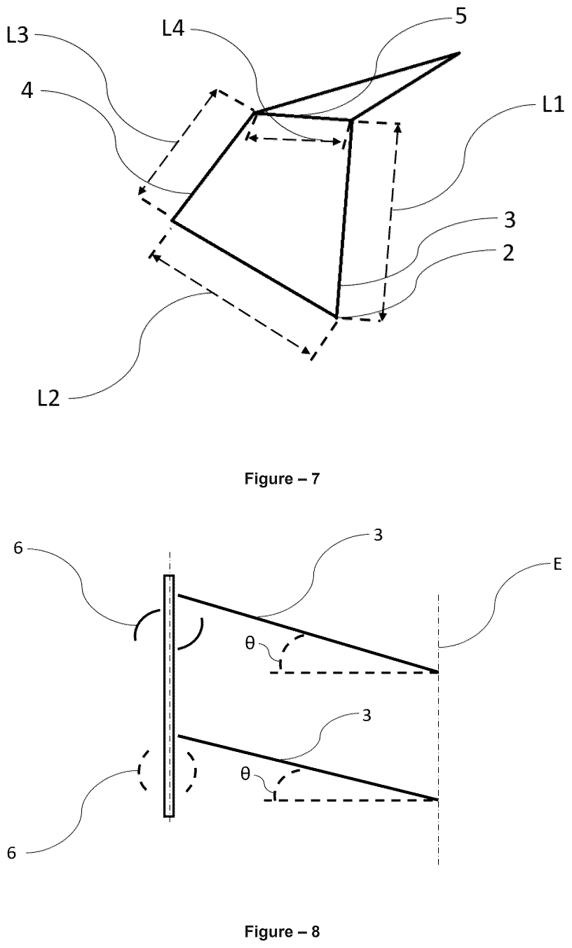

FIG. 7 is a schematic view indicating kinematic dimensions of an armrest movement mechanism.

FIG. 8 is a schematic view of the first rotary arm, rotation axis, ball joint and roll angle in an alternative embodiment of the invention.

All the parts illustrated in figures are individually assigned a reference numeral and the corresponding terms of these numbers are listed below:
1. Armrest movement mechanism
2. Body
3. First rotary arm
4. Second rotary arm
5. Armrest arm
6. Ball joint
J. Joystick
K. Armrest
L. Straight line
E. Rotation axis
θ. Roll angle
I. First position
II. Second position
III. Third position
L1. First rotary arm length
L2. Ground distance
L3. Second rotary arm length
L4. First armrest arm length

The armrest movement mechanism (1) comprises a joystick (J) used by a pilot to steer the air vehicle; at least one armrest (K), on which the pilot places his hand to use the joystick (J) in an ergonomic way; a body (2); a first rotary arm (3) and a second rotary arm (4), which are connected to the body (2) and rotate around an axis to which they are connected, so that position of the armrest (K) is changed; an armrest arm (5) with the armrest (K) thereon, which is pivotably coupled with the first rotary arm (3) and the second rotary arm (4), and enables position changes of the first rotary arm (3) and the second rotary arm (4) to be transferred to the armrest (K) (FIG. 6).

The armrest movement mechanism (1) according to the invention comprises a straight line (L) extending approximately rectilinearly between the joystick (J) and the armrest (K), approximately parallel to the longitudinal axis of the air vehicle; a first position (I) in which the armrest (K) is positioned on the straight line (L) by the pilot pushing the armrest (K) towards the joystick (J); a second position (II) in which the armrest (K) is positioned on the straight line (L) by the pilot pulling the armrest (K) towards himself; a third position (III) in which the pilot pulls the armrest (K) towards the body (2) and brings the armrest (K) closer to the body (2) with a distance to the straight line (L), wherein first rotary arm (3) and second rotary arm (4) are overlapped in the third position (III); the armrest arm (5) which allows position of the armrest (K) to be adjusted for different pilot sizes by moving the armrest (K) to the first position (I), second position (II) and third position (III), and which allows the armrest (K) to be moved aside between the pilot and the joystick (J) (FIG. 1, FIG. 2, FIG. 3, FIG. 5, FIG. 6).

The armrest movement mechanism (1) enables mechanical position of the armrest (K) to be adjusted such that the pilot can use the armrest (K) effectively according to his own body size by rotating the first rotary arm (3), the second rotary arm (4) or the armrest arm (5). The body (2), the first rotary arm (3), the second rotary arm (4) and the armrest arm (5) together constitute a four-bar mechanism. Height of the armrest (K) can be adjusted to have various distances to the ground within the armrest arm (5) (FIG. 6).

The pilot moves the armrest (K) to a desired position between the first position (I) and the second position (II) on the straight line (L), according to his own sizes. In cases the armrest (K) is not required, it can be moved to the third position (III), thereby moving the armrest (K) away from the pilot and the joystick (J) and achieving an ergonomic design by creating a large free space for the pilot. Mechanical position adjustment can be made to the armrest (K) on the straight line (L), between the first position (I) and the second position (II), with almost the same distance to the ground within the armrest arm (5). While adjusting mechanical position of the armrest (K) between the first position (I) and the second position (II), amount of rotation of the armrest (K) around its own axis is minimized, minimizing the need for angle adjustment of the armrest (K) in different positions for the pilot (FIG. 1, FIG. 2, FIG. 3, FIG. 5, FIG. 6).

In an embodiment of the invention, the armrest movement mechanism (1) comprises the first rotary arm (3) and the second rotary arm (4) that extend outward from the body (2) parallel to the ground; the armrest (K) which is moved to the third position (III) by the pilot, thanks to the connection of the first rotary arm (3) and the second rotary arm (4) to the body (2) from the same side. As the first rotary arm (3) and the second rotary arm (4) extend parallel to the ground, when the first rotary arm (3) or the second rotary arm (4) is rotated, distance of the first rotary arm (3) and the second rotary arm (4) to the ground is equal and constant. Therefore, adjustment is performed easily by the pilot only changing the mechanical position, without changing height of armrest (K). Thanks to the connection of the first rotary arm (3) and the second rotary arm (4) to the body (2) from the same side, mobility of the armrest (K) can be increased for moving it to the third position (III) (FIG. 6).

In an embodiment of the invention, the armrest movement mechanism (1) comprises the first rotary arm (3) provided as two separate parts, with one part connected to the armrest arm (5) from the upper portion thereof, and the other part connected to the armrest arm (5) from the bottom portion thereof, both in a rotatable manner around the same point; a rotation axis (E) around which the first rotary arm (3) rotates on the body (2); the first rotary arm (3) whose rotation axes (E) are collinear, thus moving along the same height from the ground, reducing the deformation of the armrest (K) caused by the weight of the pilot arm and providing easy access for the pilot. Since the first rotary arm (3) is connected to the armrest arm (5), with one part connected from the upper portion thereof, and the other part connected from the bottom portion thereof, both in a rotatable manner around the same point; instead of a built-in support, one of the first rotating arm (3) is exposed to compression and the other to tensile load, thus reducing the amount of deflection of the armrest (K) (FIG. 6).

In an embodiment of the invention, the armrest movement mechanism (1) comprises the first rotary arms (3), each extending in a curved form from the body (2) to the armrest arm (5), thus rotating with the second rotary arm (4) over each other. The curved form is, preferably, almost Z-shaped. Thus, the first rotary arm (3) contributes to the ergonomics of the pilot, in any position between the first position (I) or the second position (II) (FIG. 6).

In an embodiment of the invention, the armrest movement mechanism (1) comprises a roll angle (θ), which is the angle of directions that the first rotary arm (3) and the second rotary arm (4) extend, relative to the ground; a ball joint (6) that allows positioning of the first rotary arm (3) and the second rotary arm (4) along the roll angle (θ) relative to the body (2). Thanks to the positioning of the first rotary arm (3) and second rotary arm (4) along the roll angle (θ) relative to the body (2), when the first rotary arm (3) and second rotary arm (4) change position between the first position (I) and the second position (II), their vertical distance to the ground changes, facilitating adjustment by the pilot (FIG. 8).

In an embodiment of the invention, the armrest movement mechanism (1) comprises a first rotary arm length (L1), which is the distance between the axes around which the first rotary arm (3) is rotatably connected to the body (2) and the armrest arm (5); a ground distance (L2), which is the distance between the axes around which the first rotary arm (3) and the second rotary arm (4) are rotatably connected to the body (2); a second rotary arm length (L3), which is the distance between the axes around which the second rotary arm (4) is rotatably connected to the body (2) and the armrest arm (5); a first armrest arm length (L4), which is the distance between the axes around which the first rotary arm (3) and the second rotary arm (4) are rotatably connected to the armrest arm (5); the armrest arm (5) in which the first rotary arm length (L1), ground length (L2), second rotary arm length (L3) and first armrest arm length (L4) are in a ratio predetermined by the manufacturer, thereby enabling the armrest (K) to move on the straight line (L) between the first position (I) and the second position (II) at an angle range predetermined by the user. The ratios of the ground length (L2), second rotary arm length (L3) and first armrest arm length (L4) to the first rotary arm length (L1), respectively, are preferably 0.62, 0.61 and 0.49, as determined by the manufacturer. Therefore, a Watt four-bar approximate straight line mechanism is created, and when the pilot changes the position of the armrest (K) between the first position (I) and the second position (II), the armrest (K) moves on the straight line (L), and since the armrest rotates minimally around its own axis, the pilot does not need to rotate the armrest (K) around its own axis, thus facilitating armrest (K) adjustment for the pilot (FIG. 7).

1. An armrest movement mechanism (1) comprising a joystick (J) configured to be used by a pilot to steer the air vehicle; at least one armrest (K), on which the pilot places his hand to use the joystick (J) in an ergonomic way; a body (2); a first rotary arm (3) and a second rotary arm (4), which are connected to the body (2) and rotate around an axis to which they are connected, so that position of the armrest (K) is changed; an armrest arm (5) with the armrest (K) thereon, which is pivotably coupled with the first rotary arm (3) and the second rotary arm (4), and enables position changes of the first rotary arm (3) and the second rotary arm (4) to be transferred to the armrest (K), a straight line (L) extending approximately rectilinearly between the joystick (J) and the armrest (K), configured to be approximately parallel to the longitudinal axis of the air vehicle, wherein a first position (I) in which the armrest (K) is positioned on the straight line (L) by the pilot pushing the armrest (K) towards the joystick (J); a second position (II) in which the armrest (K) is positioned on the straight line (L) by the pilot pulling the armrest (K) towards himself; a third position (III) in which the pilot pulls the armrest (K) towards the body (2) and brings the armrest (K) closer to the body (2) with a distance to the straight line (L), wherein first rotary arm (3) and second rotary arm (4) are overlapped in the third position (III); the armrest arm (5) which allows position of the armrest (K) to be adjusted for different pilot sizes by moving the armrest (K) to the first position (I), second position (II) and third position (III), and which allows the armrest (K) to be moved aside between the pilot and the joystick (J).

2. An armrest movement mechanism (1) according to claim 1, wherein the first rotary arm (3) and the second rotary arm (4) are configured to extend outward from the body (2) parallel to the ground; the armrest (K) which is moved to the third position (III) by the pilot, thanks to the connection of the first rotary arm (3) and the second rotary arm (4) to the body (2) from the same side.

3. An armrest movement mechanism (1) according to claim 1, wherein the first rotary arm (3) provided as two separate parts, with one part connected to the armrest arm (5) from the upper portion thereof, and the other part connected to the armrest arm (5) from the bottom portion thereof, both in a rotatable manner around the same point; a rotation axis (E) around which the first rotary arm (3) rotates on the body (2); the first rotary arm (3) whose rotation axes (E) are collinear, thus moving along the same height from the ground, reducing the deformation of the armrest (K) caused by the weight of the pilot arm and providing easy access for the pilot.

4. An armrest movement mechanism (1) according to claim 1, wherein the first rotary arms (3), each extending in a curved form from the body (2) to the armrest arm (5), thus rotating with the second rotary arm (4) over each other.

5. An armrest movement mechanism (1) according to claim 1, wherein a roll angle (θ), which is the angle of directions that the first rotary arm (3) and the second rotary arm (4) extend, relative to the ground; a ball joint (6) that allows positioning of the first rotary arm (3) and the second rotary arm (4) along the roll angle (θ) relative to the body (2).

6. An armrest movement mechanism (1) according to claim 1, wherein a first rotary arm length (L1), which is the distance between the axes around which the first rotary arm (3) is rotatably connected to the body (2) and the armrest arm (5); a ground distance (L2), which is the distance between the axes around which the first rotary arm (3) and the second rotary arm (4) are rotatably connected to the body (2); a second rotary arm length (L3), which is the distance between the axes around which the second rotary arm (4) is rotatably connected to the body (2) and the armrest arm (5); a first armrest arm length (L4), which is the distance between the axes around which the first rotary arm (3) and the second rotary arm (4) are rotatably connected to the armrest arm (5); the armrest arm (5) in which the first rotary arm length (L1), ground length (L2), second rotary arm length (L3) and first armrest arm length (L4) are in a ratio predetermined by the manufacturer, thereby enabling the armrest (K) to move on the straight line (L) between the first position (I) and the second position (II) at an angle range predetermined by the user.
